(19) United States
(12) Patent Application Publication
(10) Pub. No.: US 2025/0093146 A1
(43) Pub. Date: Mar. 20, 2025

(54) METHOD FOR MONITORING BOX-TYPE OBJECT AND RELATED APPARATUS

(71) Applicant: HUAWEI TECHNOLOGIES CO., LTD., Shenzhen (CN)

(72) Inventors: Ganghua YANG, Shanghai (CN); Xu LI, Shenzhen (CN); Yanchun LI, Wuhan (CN); Zhixiang FAN, Shenzhen (CN)

(73) Assignee: HUAWEI TECHNOLOGIES CO., LTD., Shenzhen (CN)

(21) Appl. No.: 18/963,188

(22) Filed: Nov. 27, 2024

Related U.S. Application Data
(63) Continuation of application No. PCT/CN2023/092769, filed on May 8, 2023.

(30) Foreign Application Priority Data
May 31, 2022 (CN) 202210612525.5

(51) Int. Cl. G01B 7/16; H04B 1/04; H04B 1/16

(52) U.S. Cl. CPC G01B 7/16; H04B 1/04; H04B 1/16

(57) ABSTRACT

A method for monitoring a box-type object and a related apparatus are provided, for example, a monitoring device (200) or a container. The monitoring device (200) includes: a transmitting module (210), a receiving module (220), and a processing module (230). The transmitting module (210) and the receiving module (220) are located on a to-be-monitored box (130) and/or located in an area that is on a transport device of the box (130) and that is relatively static with the box (130); the transmitting module (210) is configured to transmit a test signal; the receiving module (220) is configured to receive the test signal; and the processing module (230) is configured to: determine a channel characteristic based on an electrical signal corresponding to the test signal, and determine, based on the channel characteristic and an initial channel characteristic, whether a state of the box (130) changes.

### CROSS-REFERENCE TO RELATED APPLICATIONS

This application is a continuation of International Application No. PCT/CN2023/092769, filed on May 8, 2023, which claims priority to Chinese Patent Application No. 202210612525.5, filed on May 31, 2022. The disclosures of the aforementioned applications are hereby incorporated by reference in their entireties.

### TECHNICAL FIELD

This application relates to the field of goods transportation, and more specifically, to a method for monitoring a box-type object and a related apparatus.

### BACKGROUND

During goods transportation, goods are usually loaded in a box and transported together with a transport device (for example, a vehicle, a train, a ship, or an airplane). In a goods transportation process, illegal behaviors such as stealing, smuggling, and carrying goods by damaging a door of the box or opening the box by using an electric saw or another manner are often performed by lawbreakers. If the transported goods are dangerous goods, the dangerous goods are also easily affected by external factors, and a security risk is easily caused. For example, during oil transportation, when oil is shaken violently in a tank due to an excessively high speed of an oil tank trunk, explosion may occur.

Therefore, a solution is expected to be provided, to monitor a state change of the box without damaging the box, and further identify a security risk in time.

### SUMMARY

Embodiments of this application provide a method for monitoring a box-type object and a related apparatus, to monitor a state change of the box without damaging the box, to identify a security risk in time.

According to a first aspect, this application provides a monitoring device, where the monitoring device includes: a transmitting module, located on a to-be-monitored box, and/or an area that is located on a transport device of the box and that is relatively static with the box, and configured to transmit a test signal; a receiving module, located on the box, and/or located in the area that is located on the transport device and that is relatively static with the box, and configured to receive the test signal; and a processing module, configured to: determine a channel characteristic based on an electrical signal corresponding to the test signal, and determine, based on the channel characteristic and an initial channel characteristic, whether a state of the box changes, where the initial channel characteristic represents a corresponding channel characteristic of the test signal transmitted by the transmitting module to the receiving module when the box is in an initial state.

The initial channel characteristic may be understood as a channel characteristic in the initial state, and the channel characteristic is determined based on the test signal transmitted by the transmitting module to the receiving module. For example, the initial state may include a state of the to-be-monitored box at a customhouse or a transportation node. The state of the to-be-monitored box may include a state of a housing of the box and a state of goods in the box. For example, a damage degree of the housing of the box and a location of the goods in the box. In this embodiment of this application, a phase of obtaining the initial channel characteristic may be referred to as a training phase.

The transmitting module and the receiving module may be located on the box, or in an area that is on a transport device of the box and that is relatively static with the box, so that the transmitting module and the receiving module are static relative to the box. For example, the transmitting module, the receiving module, and the box move together by using a same physical parameter, or remain static together. It should be understood that the physical parameter may include at least one of the following: a speed, an acceleration, or a vibration frequency.

Based on the foregoing design, the transmitting module that is relatively static with the box transmits the test signal, the receiving module that is relatively static with the box receives the test signal, and then the processing module determines the channel characteristic based on the electrical signal corresponding to the test signal, so that when the state of the box changes, for example, a location of the goods moves or the box is damaged, it can be monitored that the channel characteristic changes relative to the initial channel characteristic. In other words, regardless of whether the box is damaged or the state of the goods in the box changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

With reference to the first aspect, in some possible designs, the test signal includes a mechanical wave signal, a direct current signal, or an electromagnetic wave signal.

When the test signal is the mechanical wave signal, the mechanical wave signal may be transmitted along the housing of the box through vibration. However, a vibration characteristic of the mechanical wave signal when the housing of the box is damaged is greatly different from a vibration characteristic of the mechanical wave signal when the housing is not damaged. In other words, when the housing of the box is damaged, the channel characteristic determined by the processing module based on the electrical signal corresponding to the mechanical wave signal is greatly different from the channel characteristic determined by the processing module based on the electrical signal corresponding to the mechanical wave signal when the housing of the box is not damaged. Therefore, the monitoring device may determine, by comparing the channel characteristics in the two different cases, whether the state of the box changes.

When the test signal is the direct current signal, the direct current signal may be conductively transmitted along the housing of the box, and a voltage difference between the receiving module and the transmitting module when the housing of the box is damaged differs greatly from a voltage difference between the receiving module and the transmitting module when the housing is not damaged. In other words, when the housing of the box is damaged, a channel characteristic determined by the processing module based on a direct current signal received from the receiving module differs greatly from a channel characteristic determined by the processing module based on a direct current signal received from the receiving module when the housing of the box is not damaged. Therefore, the monitoring device may determine, by comparing the channel characteristics in the two different cases, whether the state of the box changes.

When the test signal is the electromagnetic wave signal, the electromagnetic wave signal may be an electromagnetic wave signal or a transient electromagnetic signal.

The electromagnetic wave signal may be oscillating and transmitted in the box, and a vibration characteristic of the electromagnetic wave when the housing of the box is damaged or the state of the goods in the box does not maintain the original loading state is greatly different from the vibration characteristic of the electromagnetic wave when the housing is not damaged or the state of the goods in the box remains the original loading state. That is, when the housing of the box is damaged or the state of the goods in the box changes compared with the original loading state, a channel characteristic determined by the processing module based on the electromagnetic wave signal received from the receiving module is greatly different from the channel characteristic determined by the processing module when the housing of the box is not damaged or the state of the goods in the box does not change compared with the original loading state. Therefore, the monitoring device may determine, by comparing the channel characteristics in the two different cases, whether the state of the box changes.

With reference to the first aspect, in some possible designs, when the transmitting module and the receiving module are located in the box, the transmitting module and the receiving module are specifically located on at least one of an outer wall, a corner, an edge, a door, or an air vent of a housing of the box.

It should be understood that, when the transmitting module and the receiving module are located on edges of the housing of the box, the transmitting module and the receiving module may simultaneously cover two side walls of the housing of the box; or when the transmitting module and the receiving module are located on corners of the housing of the box, the transmitting module and the receiving module may simultaneously cover three surfaces of the housing of the box.

Optionally, the transmitting module and the receiving module may be fixed on the box in a magnetic suction manner or a buckle manner.

With reference to the first aspect, in some possible designs, an area that is on the transport device of the box and that is relatively static with the box includes at least one of a chassis, a frame, a rear suspension, a fuel tank, or a drive bridge of the transport device.

In other words, when being deployed, the transmitting module and the receiving module may be deployed at one or more of the foregoing locations of the box, and in the area that is on the transport device of the box and that is relatively static with the box.

When the transmitting module and the receiving module are deployed in the relatively static area, because the transmitting module and the to-be-monitored box remain in a relatively static state, the receiving module and the to-be-monitored box also remain in the relatively static state. In other words, the transmitting module, the receiving module, and the to-be-monitored box remain in the relatively static state. Therefore, accuracy of determining the state of the box by the monitoring device can be ensured, and monitoring precision can be improved.

With reference to the first aspect, in some possible designs, the transmitting module includes M transmitter front-ends and P processing units, each of the P processing units corresponds to at least one of the M transmitter front-ends, and M and P are natural numbers; each processing unit is configured to: generate one electrical signal, and send the electrical signal to at least one corresponding transmitter front-end; and each transmitter front-end is configured to transmit a test signal, where the test signal corresponds to the received electrical signal.

Optionally, P=1, and M>1, the processing unit corresponds to the M transmitter front-ends, and the processing unit is configured to: generate the electrical signal, and send the electrical signal to each transmitter front-end.

Optionally, 1<P<M, each processing unit corresponds to at least one transmitter front-end, and each processing unit is configured to: generate the electrical signal, and send the electrical signal to the at least one corresponding transmitter front-end.

Optionally, M=P, the P processing units are in one-to-one correspondence with the M transmitter front-ends, and each processing unit is configured to: generate the electrical signal, and send the electrical signal to the corresponding transmitter front-end.

In an implementation, the transmitting module further includes Y transmitter circuits, where P≤Y≤M.

In this case, each processing unit in the P processing units may be specifically configured to: generate one first electrical signal, and send the first electrical signal to a corresponding transmitter circuit; each transmitter circuit may be configured to process the received first electrical signal to obtain a second electrical signal, and send the second electrical signal to a corresponding transmitter front-end; and each transmitter front-end may be specifically configured to transmit the test signal based on the received second electrical signal.

Optionally, the processing operation may include at least one of the following: amplification, filtering, up-conversion, and attenuation.

With reference to the first aspect, in some possible designs, the receiving module includes N receiver front-ends and Q processing units, each of the Q processing units corresponds to at least one of the N receiver front-ends, and N and Q are natural numbers; each receiver front-end is configured to: receive M test signals from M transmitter front-ends, and send the M test signals to a corresponding processing unit; and each processing unit is configured to send electrical signals corresponding to the received M test signals to the processing module.

Optionally, Q=1, and N>1, the processing unit corresponds to the N receiver front-ends, and each receiver front-end is configured to send the received M test signals to the processing unit.

Optionally, 1<Q<N, each processing unit corresponds to at least one receiver front-end, and each receiver front-end is configured to send the received M test signals to corresponding processing units.

Optionally, N=Q, the Q processing units are in one-to-one correspondence with the N receiver front-ends, and each receiver front-end is configured to send the received M test signals to the corresponding processing units.

In an implementation, the receiving module further includes: Z receiving circuits, where Q≤Z≤N.

In some possible designs, each receiver front-end may be specifically configured to receive the M test signals from the M transmitter front-ends, and send M third electrical signals corresponding to the received M test signals to a corresponding receiving circuit; and each receiving circuit may be configured to process received M×i third electrical signals to obtain M×i fourth electrical signals, and send the M×i fourth electrical signals to a corresponding processing unit. Each processing unit may be specifically configured to send the received M×i×j fourth electrical signals to the processing module. i is a quantity of receive end heads corresponding to one receiving circuit, j is a quantity of receiving circuits corresponding to one processing unit, and i and j are natural numbers. In other words, each receiver front-end may receive the test signals transmitted by all the transmitter front-ends, and quantities of test signals received by all the receiver front-ends are the same.

In some possible designs, each receiver front-end may be specifically configured to: receive k test signals from k transmitter front-ends, where k<M; and send k third electrical signals corresponding to the received k test signals to a corresponding receiving circuit. Each receiving circuit may be configured to process received k×i third electrical signals to obtain k×i fourth electrical signals, and send the k×i fourth electrical signals to a corresponding processing unit. Each processing unit may be specifically configured to send received k×i×j fourth electrical signals to the processing module. In other words, each receiver front-end may receive test signals transmitted by some of the transmitter front-ends, and quantities of test signals received by all the receiver front-ends may be different.

Optionally, the processing operation may include at least one of the following: amplification, filtering, down-conversion, and attenuation.

With reference to the first aspect, in some possible designs, the test signal is the electrical signal, and the M transmitter front-ends and the N receiver front-ends are electrodes.

When the test signal is the electrical signal, the processing unit may directly determine a channel characteristic based on the electrical signal. This reduces a data processing amount and improves processing efficiency.

With reference to the first aspect, in some possible designs, the test signal is a mechanical wave signal obtained by converting the electrical signal, and the M transmitter front-ends and the N receiver front-ends are transducers; or the test signal is an electromagnetic wave signal obtained by converting the electrical signal, and the M transmitter front-ends and the N receiver front-ends are antennas.

With reference to the first aspect, in some possible designs, the M transmitter front-ends are centrally distributed or discretely distributed, and the N receiver front-ends are centrally distributed or discretely distributed.

When the transmitter front-end and/or the receiver front-end are/is deployed in a centralized and distributed manner, it is convenient for a staff to place, thereby reducing a deployment workload of the staff.

When the transmitter front-end and/or the receiver front-end are/is deployed in a discrete distribution manner, a coverage of the test signal is wider and more comprehensive. This improves monitoring precision of a monitoring device.

With reference to the first aspect, in some possible designs, the initial channel characteristic is obtained through training in the initial state.

The initial channel characteristic may also be understood as a channel characteristic of a medium through which the test signal passes each time a transport device that transports the goods arrives at a customhouse or a transportation node and when the test signal transmitted by the transmitting module arrives at the receiving module at the current customhouse or transportation node, and the channel characteristic may represent a current state of the box. The current state of the box is the initial state of the box.

With reference to the first aspect, in some possible designs, the receiving module and the processing module are integrated.

The receiving module and the processing module may be deployed in an integrated manner, in other words, the processing module may be transported together with the box. Therefore, in a process of goods transportation, the monitoring device may monitor the state of the box in real time.

With reference to the first aspect, in some possible designs, the device further includes an alarm module; the processing module is further configured to send an alarm instruction to the alarm module when determining that the state of the box changes; and the alarm module is configured to send an alarm signal based on the alarm instruction.

According to a second aspect, this application provides a container, where the container includes a box and a monitoring device in any one of the first aspect or the possible designs of the first aspect.

Based on the foregoing design, the transmitting module that is relatively static with the box transmits the test signal, the receiving module that is relatively static with the box receives the test signal, and then the processing module determines the channel characteristic based on the electrical signal corresponding to the test signal, so that when the state of the box changes, for example, a location of goods moves or the box is damaged, it can be monitored that the channel characteristic changes relative to the initial channel characteristic. In other words, regardless of whether the box is damaged or the state of the goods in the box changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

According to a third aspect, this application provides a method for monitoring a box-type object, applied to the device in any one of the first aspect or the possible designs of the first aspect. The method may be performed by a controller, or may be performed by a component (for example, a chip or a chip system) configured in the controller, or may be implemented by a logical module or software that can implement all or some of controller functions. This is not limited in this application.

For example, the method includes: controlling a transmitting module to transmit a test signal; controlling a receiving module to receive the test signal; and controlling a processing module to determine a channel characteristic of an electrical signal corresponding to the test signal, and determine, based on the channel characteristic and an initial channel characteristic, whether a state of the box-type object changes, where the initial channel characteristic represents a corresponding channel characteristic of the test signal transmitted by the transmitting module to the receiving module when the box-type object is in an initial state.

It should be understood that the box-type object in the third aspect may be referred to as a box for short, for example, may include the box in the first aspect and the second aspect.

Based on the foregoing design, the transmitting module that is relatively static with the box is controlled to transmit the test signal, the receiving module that is relatively static with the box is controlled to receive the test signal, and then the processing module is controlled to determine the channel characteristic based on the electrical signal corresponding to the test signal, so that when the state of the box changes, for example, a location of goods moves or the box is damaged, it can be monitored that the channel characteristic changes relative to the initial channel characteristic. In other words, regardless of whether the box is damaged or the state of the goods in the box changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

With reference to the third aspect, in some possible implementations, the method further includes: performing training based on the test signal transmitted by the transmitting module to the receiving module in the initial state, to obtain the channel characteristic in the initial state.

According to a fourth aspect, this application provides an apparatus for monitoring a box-type object, including a processor. The processor is configured to perform the method for monitoring a box-type object according to any one of the third aspect or the possible implementations of the third aspect.

Optionally, the apparatus may further include a memory, configured to store instructions and data. The memory is coupled to the processor. When executing the instructions stored in the memory, the processor may implement the methods described in the foregoing aspects.

Optionally, the apparatus may further include a communication interface. The communication interface is used by the apparatus to communicate with another device. For example, the communication interface may be a transceiver, a circuit, a bus, a module, or another type of communication interface.

According to a fifth aspect, this application provides a chip system. The chip system includes at least one processor, configured to support implementation of the function in any one of the third aspect and the possible implementations of the third aspect, for example, receiving or processing a test signal in the foregoing method.

In a possible design, the chip system further includes a memory. The memory is configured to store program instructions and data. The memory is located inside the processor or outside the processor.

The chip system may include a chip, or may include the chip and another discrete component.

According to a sixth aspect, this application provides a computer-readable storage medium. The computer storage medium stores a computer program (which may also be referred to as code or instructions). When the computer program is run by a processor, so that the method in any one of the third aspect or the possible implementations of the third aspect is performed.

According to a seventh aspect, this application provides a computer program product. The computer program product includes a computer program (which may also be referred to as code or instructions). When the computer program is run, the method in any one of the third aspect or the possible implementations of the third aspect is performed.

It should be understood that the fourth aspect to the seventh aspect of this application correspond to the technical solutions of the third aspect of this application, and beneficial effects achieved by the aspects and corresponding feasible implementations are similar. Details are not described again.

### BRIEF DESCRIPTION OF DRAWINGS

FIG. 1 is a diagram of a goods transportation scenario according to an embodiment of this application;

FIG. 2 is a block diagram of a monitoring device according to an embodiment of this application;

FIG. 3 is a diagram of deployment locations of a transmitting module and a receiving module according to an embodiment of this application;

FIG. 4 is a schematic flowchart of a method for monitoring a box-type object according to an embodiment of this application; and

FIG. 5 is a block diagram of an apparatus for monitoring a box-type object according to an embodiment of this application.

### DESCRIPTION OF EMBODIMENTS

The following describes technical solutions of this application with reference to accompanying drawings.

The technical solutions provided in this application may be applied to various goods transportation scenarios, for example, customhouse transportation, cold chain transportation, and dangerous goods transportation (for example, oil transportation by an oil tanker).

To clearly describe the technical solutions in embodiments of this application, terms such as “first” and “second” are used in embodiments of this application to distinguish between same items or similar items whose functions and effects are basically the same. For example, a first electrical signal and a second electrical signal are merely used to distinguish between different electrical signals, and a sequence of the first electrical signal and the second electrical signal is not limited. A person skilled in the art may understand that the words such as “first” and “second” do not limit a quantity and a location, and the words such as “first” and “second” are not limited to be definitely different.

In embodiments of this application, “at least one” means one or more, and “a plurality of” means two or more. The term “and/or” describes an association relationship between associated objects, and represents that three relationships may exist. For example, A and/or B may represent the following cases: Only A exists, both A and B exist, and only B exists, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, at least one of a, b, or c may indicate a, b, c, a and b, a and c, b and c, or a, b, and c. a, b, and c may be singular or plural.

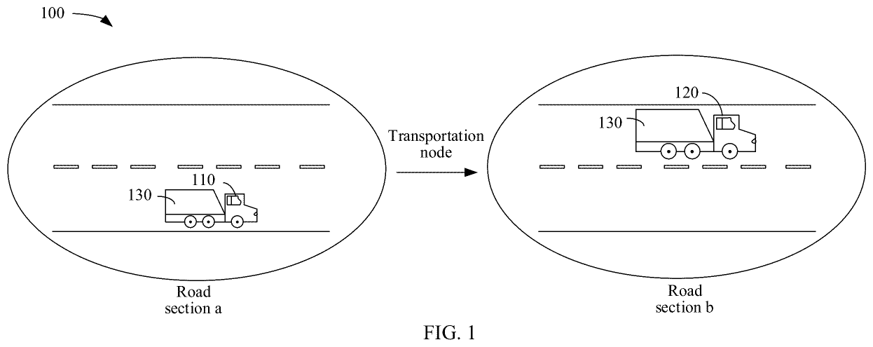

FIG. 1 is a diagram of a goods transportation scenario according to an embodiment of this application. In the scenario 100 shown in FIG. 1, a vehicle 110 carries a box 130 and travels on a road section a, and the box 130 is loaded with goods that need to be transported. When the vehicle 110 transports the box 130 to a transportation node, the vehicle is changed at the transportation node, and the box 130 is offloaded from the vehicle 110, and then reloaded to a vehicle 120. The vehicle 120 carries the box 130 and continues to travel on a next road section, namely, a road section b, until the box loaded with the goods is transported to a destination.

It should be understood that a quantity of transportation nodes shown in FIG. 1 is merely an example for description. The goods transportation scenario shown in FIG. 1 may further include more transportation nodes, or may include a transportation node such as a customhouse. This is not limited in this application.

Currently, in a goods transportation process, to ensure safety of the goods in the box, a manner of sealing a door of the box or additionally installing a secure smart lock on the door is usually used to prevent illegal behaviors such as stealing, smuggling, and carrying the goods by lawbreakers by opening the door. However, the two manners can only monitor the door to a certain extent, the lawbreaker can still achieve an objective of illegal theft by damaging another part of the box (for example, an outer wall of the box), and safety of the goods in the box cannot be ensured. Even if a camera is additionally installed on the box, although an illegal theft behavior can be monitored, because the camera monitors the box according to a photographic imaging principle, power consumption is high and costs are high in this manner. In addition, to avoid a legal risk, the box loaded with the goods is generally not allowed to be opened, and the camera can only be installed on the outer wall of the box, and can only monitor an environment around the box. However, regardless of whether a sealing manner, a manner of additionally adding a secure smart lock, or a manner of additionally adding a camera is used, when the transported goods are dangerous goods, a state of the goods in the box (for example, whether the goods are greatly shifted) cannot be monitored in these manners, and a potential security risk cannot be avoided. For example, during oil transportation, an excessively high speed may cause oil to shake violently in an oil box; or during firework transportation, an excessively high speed may cause fireworks to shift greatly in the box, or even cause mutual friction. This may cause an explosion risk. However, in these manners, a state of the oil in the box and a state of the fireworks in the box cannot be monitored. Therefore, in the current solution, a state change of the box cannot be monitored without damaging the box, and a potential security risk cannot be avoided.

In view of this, this application provides a monitoring device. The monitoring device includes a transmitting module, a receiving module, and a processing module. The transmitting module is located on a to-be-monitored box and/or located in an area that is on a transport device of the box and that is relatively static with the box, and is configured to send a test signal. The receiving module is located on the to-be-monitored box and/or located in the area that is on the transport device of the box and that is relatively static with the box, and is configured to receive the test signal. The processing module is configured to: determine a channel characteristic based on an electrical signal corresponding to the test signal, and determine, based on the channel characteristic and an initial channel characteristic, whether a state of the box changes. The transmitting module that is relatively static with the box transmits the test signal, the receiving module that is relatively static with the box receives the test signal, and then the processing module determines the channel characteristic based on the electrical signal corresponding to the test signal, so that when the state of the box changes, for example, a location of goods moves or the box is damaged, it can be monitored that the channel characteristic changes relative to the initial channel characteristic. In other words, regardless of whether the box is damaged or a state of the goods in the box changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

To better understand the monitoring device, a container, and a method for monitoring the container that are provided in embodiments of this application, the following describes the technical solutions in this application with reference to the accompanying drawings.

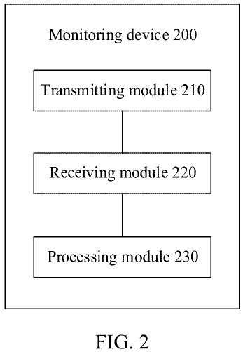

FIG. 2 is a block diagram of a monitoring device according to an embodiment of this application. As shown in FIG. 2, the monitoring device 200 includes a transmitting module 210, a receiving module 220, and a processing module 230.

The following separately describes the transmitting module 210, the receiving module 220, and the processing module 230 in detail.

### Transmitting Module 210:

First, a deployment location of the transmitting module 210 is described.

The transmitting module 210 is located on a to-be-monitored box and/or located in an area that is on a transport device of the box and that is relatively static with the box.

The to-be-monitored box may be understood as a box whose state needs to be monitored in a goods transportation process. The state of the box may be a state of a housing of the box and a state of goods in the box. The state of the housing of the box may be, for example, a degree of damage to the housing of the box, and the state of the goods in the box may be, for example, a location of the goods in the box.

For example, during goods transportation, a state of a housing of a container that transports the goods needs to be monitored, and whether there is an illegal theft behavior is determined based on the state of the housing of the box. When the transported goods are dangerous goods, a state of the dangerous goods in the box further needs to be monitored, and whether there is a potential danger is determined based on the state of the dangerous goods in the box. Therefore, these boxes that need to be monitored may be used as to-be-monitored boxes.

It should be understood that a shape of the box in this application is not limited to a container-type cuboid, and any three-dimensional structure that is hollow inside and whose outer surface can be enclosed may be considered as a box. For example, a cylindrical oil tank that can store oil may also be regarded as a box.

In this application, the transmitting module 210 may be deployed on the to-be-monitored box, and may be specifically located on at least one of an outer wall, a corner, an edge, a door, or an air vent of the housing of the box. It should be understood that the transmitting module 210 may be deployed at any location of the housing of the box. This is not limited in this application.

Optionally, when the transmitting module is deployed on the outer wall or the door of the housing of the box, a shape of the transmitting module may be a long strip shape; when the transmitting module is deployed on the edge of the housing of the box, a shape of the transmitting module may be a corner shape; or when the transmitting module is deployed on the corner or the air vent of the housing of the box, a shape of the transmitting module may be a starfish shape. It should be understood that a specific shape of the transmitting module is not limited in this application.

The transport device may be a transport tool for transporting the to-be-monitored box, for example, a vehicle, a train, a ship, or an airplane.

“Relatively static” may be understood as that the transmitting module 210 and the to-be-monitored box remain in a relatively static state, to be specific, the transmitting module 210 and the to-be-monitored box move together, or remain static together. It should be understood that, when the transmitting module and the to-be-monitored box move together, physical parameters such as speeds, accelerations, and vibration frequencies of the transmitting module and the to-be-monitored box are completely consistent.

In this application, the transmitting module 210 may alternatively be deployed in the area that is on the transport device and that is relatively static with the box.

Optionally, the relatively static area includes at least one of a chassis, a frame, a rear suspension, a fuel tank, or a drive bridge of the transport device.

It should be understood that the relatively static area corresponds to a non-relatively static area, and the non-relatively static area may include a location such as a vehicle head or a tire of the transport device. The non-relatively static area may be understood as that the transmitting module 210 and the to-be-monitored box cannot remain in a relatively static state, and when the transmitting module and the to-be-monitored box move together, consistency of the physical parameters cannot be maintained.

Optionally, when the transmitting module 210 is deployed, for a magnetically absorbent box, if a housing of the box is a rigid body of a metal part, the transmitting module may be magnetically adsorbed onto the to-be-monitored box and/or on the relatively static area. For a box that is not magnetically absorbent, a clamping manner may be used to clamp the transmitting module on the to-be-monitored box and/or on the relatively static area.

It should be understood that a person skilled in the art may also fasten the transmitting module 210 in another manner. This is not limited in this application.

Second, a structure of the transmitting module 210 is described.

The transmitting module 210 includes M transmitter front-ends and P processing units, each of the P processing units corresponds to at least one of the M transmitter front-ends, and M and P are natural numbers.

When P=1 and M>1, the M transmitter front-ends share one processing unit. When 1<P<M, each processing unit corresponds to at least one transmitter front-end. For example, when there are two processing units, and there are three transmitter front-ends, one processing unit corresponds to one transmitter front-end, and the other processing unit may correspond to the remaining two transmitter front-ends. When P=M, the P processing units are in one-to-one correspondence with the M transmitter front-ends.

The transmitting module 210 may further include Y transmitter circuits, where P≤Y≤M.

When Y=1, the M transmitter front-ends share one transmitter circuit. When Y=M, the M transmitter front-ends are in one-to-one correspondence with the Y transmitter circuits. When P<Y<M, each processing unit corresponds to at least one transmitter circuit, and each transmitter circuit corresponds to at least one transmitter front-end. For example, when there is one processing unit, there are two transmitter circuits, and there are five transmitter front-ends, the processing unit may correspond to the two transmitter circuits, one transmitter circuit may correspond to two transmitter front-ends, and the other transmitter circuit may correspond to the remaining three transmitter front-ends.

It should be understood that, when P=Y=1, the M transmitter front-ends share one processing unit and one transmitter circuit. When P=Y=M, each processing unit corresponds to one transmitter circuit, and each transmitter circuit corresponds to one transmitter front-end.

It should be understood that the M transmitter front-ends, the P processing units, and the Y transmitter circuits may all be deployed on the to-be-monitored box, or may all be deployed in the area that is on the transport device and that is relatively static with the box, or some of the M transmitter front-ends, the P processing units, and the Y transmitter circuits may be deployed on the to-be-monitored box, and the other is deployed in the area that is on the transport device and that is relatively static with the box. For example, the P processing units and the Y transmitter circuits may be deployed in the area that is on the transport device and that is relatively static with the box, and the M transmitter front-ends are deployed on the to-be-monitored box. Alternatively, some of the M transmitter front-ends, some of the P processing units, and some of the Y transmitter circuits may be deployed on the to-be-monitored box, and other transmitter front-ends of the M transmitter front-ends, other processing units of the P processing units, and other transmitter circuits of the Y transmitter circuits are deployed in the area that is on the transport device and that is relatively static with the box.

It should be understood that, because each processing unit has a corresponding transmitter circuit and a corresponding transmitter front-end, to ensure good signal transmission, when the processing unit, the transmitter circuit, and the transmitter front-end are deployed, a processing unit, a transmitter circuit, and a transmitter front-end that have a correspondence are deployed close to each other.

For example, the processing unit corresponds to two transmitter circuits, and the transmitter circuit corresponds to three transmitter front-ends. It is assumed that the processing unit is deployed in the area that is on the transport device and that is relatively static with the box, and the transmitter circuit and the transmitter front-end are deployed on the to-be-monitored box. Although different parts of the transmitting module are deployed at different locations, when the processing unit, the transmitter circuit, and the transmitter front-end are deployed at specific locations, the location at which the processing unit is deployed is close to the location at which the transmitter circuit is deployed, and the location at which the transmitter circuit is deployed is close to the location at which the transmitter front-end is deployed. For example, the processing unit may be deployed on the chassis of the transport device, the two transmitter circuits may be deployed on a lower surface that is of the box and that is close to the chassis, and the three transmitter front-ends may be deployed on a side wall that is of the box and that is close to the lower surface of the box.

Optionally, the M transmitter front-ends may be centrally distributed or discretely distributed.

In an example, a groove may be designed in advance, and the M transmitter front-ends are fastened in the groove. A worker only needs to attach, to the outer wall of the to-be-monitored box, the groove in which the M transmitter front-ends are fastened, or clamp the groove on the edge of the box. The operation is simple and quick. It should be understood that a specific shape of the groove is not limited in this application. For example, the groove may be in a long strip shape.

In another example, a worker may deploy some transmitter front-ends on the outer wall of the housing of the to-be-monitored box, deploy some transmitter front-ends on the edge of the box, deploy some transmitter front-ends on the air vent, and even deploy some transmitter front-ends in the area that is on the transport device and that is relatively static with the box.

Finally, a function of the transmitting module 210 is described.

The transmitting module 210 is configured to send a test signal, where the test signal is transmitted to the receiving module 220 through a medium, and the medium includes the housing of the to-be-monitored box, air inside the box, or air outside the box.

The test signal may include a mechanical wave signal, a direct current signal, or an electromagnetic wave signal. It should be understood that the electromagnetic wave signal may include a transient electromagnetic signal or an electromagnetic wave signal.

As described above, the transmitting module 210 includes the P processing units and the M transmitter front-ends.

Each processing unit is configured to: generate one electrical signal, and send the electrical signal to at least one corresponding transmitter front-end. Each transmitter front-end is configured to transmit a test signal, where the test signal corresponds to the received electrical signal.

In an example, when P=1 and M>1, the processing unit may generate one electrical signal, and send the electrical signal to each transmitter front-end. After receiving the electrical signal, each transmitter front-end transmits the test signal based on the received electrical signal.

In another example, when P=M, each processing unit may generate one electrical signal, and send the electrical signal to one corresponding transmitter front-end. After receiving the electrical signal, each transmitter front-end transmits the test signal based on the received electrical signal.

Further, because the transmitting module 210 may further include the Y transmitter circuits, each processing unit may be specifically configured to: generate one first electrical signal, and send the first electrical signal to a corresponding transmitter circuit. Each transmitter circuit may be configured to: process the received first electrical signal to obtain a second electrical signal, and send the second electrical signal to a corresponding transmitter front-end. Each transmitter front-end may be specifically configured to transmit the test signal based on the received second electrical signal.

For example, when P=Y=1 and M>1, the processing unit may generate one first electrical signal, and send the first electrical signal to the transmitter circuit. The transmitter circuit processes the first electrical signal to obtain the second electrical signal, and sends the second electrical signal to each transmitter front-end. After receiving the second electrical signal, each transmitter front-end transmits the test signal based on the second electrical signal.

In another example, when P=Y=M, each processing unit may generate one first electrical signal, and send the first electrical signal to one corresponding transmitter circuit. Each transmitter circuit processes the received first electrical signal to obtain the second electrical signal, and sends the second electrical signal to one corresponding transmitter front-end. After receiving the second electrical signal, each transmitter front-end transmits the test signal based on the second electrical signal.

An operation of processing the first electrical signal by the transmitter circuit may include at least one of the following: amplification, filtering, up-conversion, and attenuation.

In this application, the first electrical signal and the second electrical signal may be digital signals, or may be analog signals. This is not limited in this application.

For example, it is assumed that the first electrical signal is the digital signal, and the second electrical signal is the analog signal. In this case, the processing module generates one digital signal, and sends the digital signal to a corresponding transmitter circuit. When receiving the digital signal, the transmitter circuit performs amplification, filtering, up-conversion, and attenuation on the digital signal, performs digital-to-analog conversion to obtain an analog signal, and sends the analog signal to a corresponding transmitter front-end. The transmitter front-end may transmit a corresponding test signal based on the received analog signal.

Optionally, when the test signal is the electrical signal, the M transmitter front-ends are electrodes.

When the transmitter front-end is the electrode, the test signal transmitted by the transmitter front-end is still the electrical signal. In this case, when receiving the second electrical signal of the transmitter circuit, the transmitter front-end directly transmits the second electrical signal as the test signal without performing a processing operation.

Optionally, when the test signal is a mechanical wave signal obtained by converting the electrical signal, the M transmitter front-ends are transducers; or when the test signal is an electromagnetic wave signal obtained by converting the electrical signal, the M transmitter front-ends are antennas.

When the transmitter front-end is the transducer, the test signal transmitted by the transmitter front-end is the mechanical wave signal. In this case, when receiving the second electrical signal of the transmitter circuit, the transmitter front-end needs to convert the second electrical signal into the mechanical wave signal, and then transmits the mechanical wave signal as the test signal. When the transmitter front-end is the antenna, the test signal transmitted by the transmitter front-end is the electromagnetic wave signal. In this case, when receiving the second electrical signal of the transmitter circuit, the transmitter front-end needs to convert the second electrical signal into the electromagnetic wave signal, and then transmits the electromagnetic wave signal as the test signal.

When the transmitter front-end is the antenna, the transmitter front-end may be deployed on the air vent or the corner of the to-be-monitored box; or when the transmitter front-end is the electrode or the transducer, the transmitter front-end may be deployed on the outer wall, the door, or the edge of the to-be-monitored box.

### Receiving Module 220:

First, a deployment location of the receiving module 220 is described.

The receiving module 220 is located on the to-be-monitored box and/or located in the area that is on the transport device of the box and that is relatively static with the box.

In this application, when the receiving module 220 may also be deployed on the to-be-monitored box, the receiving module 220 may be specifically located on at least one of the outer wall, the corner, the edge, the door, or the air vent of the housing of the box. It should be understood that the receiving module 220 may also be deployed at any location of the housing of the box. This is not limited in this application.

It should be understood that a person skilled in the art may design a specific shape of the receiving module based on an actual requirement. This is not limited in this application.

“Relatively static” may be understood as that the receiving module 220 and the to-be-monitored box remain in a relatively static state, to be specific, the receiving module 220 and the to-be-monitored box move together, or remain static together.

It should be understood that, when both the transmitting module 210 and the receiving module 220 are deployed in the area that is on the transport device and that is relatively static with the box, the transmitting module 210, the receiving module 220, and the to-be-monitored box all remain in a relatively static state. For example, when the transmitting module 210, the receiving module 220, and the to-be-monitored box move synchronously, physical parameters such as speeds, accelerations, and vibration frequencies of the transmitting module 210, the receiving module 220, and the to-be-monitored box are consistent.

In this application, the receiving module 220 may also be deployed in the area that is on the transport device and that is relatively static with the box. The relatively static area also includes at least one of the chassis, the vehicle frame, the rear suspension, the fuel tank, or the drive bridge of the transport device.

Optionally, when the receiving module 220 is deployed, the receiving module 220 may also be fastened in a magnetic absorbing manner or a clamping manner.

Second, a structure of the receiving module 220 is described.

The receiving module 220 includes N receiver front-ends and Q processing units, each of the Q processing units corresponds to at least one of the N receiver front-ends, and N and Q are natural numbers.

When Q=1, the N receiver front-ends share one processing unit. When 1<Q<N, each processing unit corresponds to at least one receiver front-end. When Q=N, the Q processing units are in one-to-one correspondence with the N receiver front-ends.

The receiving module 220 may further include Z receiving circuits, where Q≤Z≤N.

When Z=1, the N receiver front-ends share one receiving circuit. When Z=N, the N receiver front-ends are in one-to-one correspondence with the Z receiving circuits. When Q<Z<N, each processing unit corresponds to at least one receiving circuit, and each receiving circuit corresponds to at least one receiver front-end.

Similarly, it may be understood that, when Q=Z=1, the N receiver front-ends share one processing unit and one receiving circuit. When Q=Z=N, each processing unit corresponds to one receiving circuit, and each receiving circuit corresponds to one receiver front-end.

Similarly, the N receiver front-ends, the Z receiving circuits, and the Q processing units may all be deployed on the to-be-monitored box, or may all be deployed in the area that is on the transport device and that is relatively static with the box, or some of the N receiver front-ends, the Z receiving circuits, and the Q processing units may be deployed on the to-be-monitored box, and the other is deployed in the area that is on the transport device and that is relatively static with the box.

When a processing unit, a receiving circuit, and a receiver front-end that have a correspondence are deployed, the processing unit, the receiving circuit, and the receiver front-end that have the correspondence may also be deployed close to each other.

It should be understood that a quantity relationship between the N receiver front-ends and the M transmitter front-ends is not limited in this application, and N and M may be the same or may be different.

Optionally, the N receiver front-ends may also be centrally distributed or discretely distributed.

It should be understood that a deployment manner and the structure of the receiving module 220 are similar to those of the transmitting module 210. For specific related descriptions, refer to the foregoing descriptions. Details are not described herein again.

Finally, a function of the receiving module 220 is described.

The receiving module 220 is configured to receive the test signal, and may be specifically configured to: receive the test signal from the transmitting module 210, and send an electrical signal corresponding to the test signal to the processing module 230.

As described above, the test signal transmitted by the transmitting module 210 may include the mechanical wave signal, the direct current signal, or the electromagnetic wave signal. Therefore, the test signal received by the receiving module 220 may also include the mechanical wave signal, the direct current signal, or the electromagnetic wave signal.

As described above, the receiving module 220 includes the Q processing units and the N receiver front-ends.

Each receiver front-end is configured to: receive M test signals from the M transmitter front-ends, and send the M test signals to a corresponding processing unit. Each processing unit is configured to send electrical signals corresponding to the received M test signals to the processing module 230.

It should be understood that, regardless of whether a quantity of transmitter front-ends is the same as a quantity of receiver front-ends, when the test signal is the mechanical wave signal or the direct current signal, a mechanical wave signal or a direct current signal transmitted by each transmitter front-end may be diffused and propagated in any direction along the box; or when the test signal is the electromagnetic wave signal, an electromagnetic wave signal transmitted by each transmitter front-end may also be propagated in any direction in the box, and oscillate back and forth in the box through reflection. Therefore, each receiver front-end may receive the test signals from all the transmitter front-ends, in other words, each receiver front-end may receive the M test signals.

In an example, when Q=1 and N>1, each receiver front-end may receive the M test signals from the M transmitter front-ends, and each receiver front-end sends the M received test signals to the processing unit. The processing unit sends M×N electrical signals corresponding to M×N test signals to the processing module 230.

In another example, when Q=N, each receiver front-end may receive the M test signals from the M transmitter front-ends, and each receiver front-end sends, to one corresponding processing unit, the M test signals received by the receiver front-end. Each processing unit sends M electrical signals corresponding to the M test signals to the processing module 230.

Further, the receiving module 220 may further include the Z receiving circuits, where Q≤Z≤N.

In a possible design, each receiver front-end may be specifically configured to: receive the M test signals from the M transmitter front-ends, and send M third electrical signals corresponding to the received M test signals to a corresponding receiving circuit. Each receiving circuit may be configured to: process received M×i third electrical signals to obtain M×i fourth electrical signals, and send the M×i fourth electrical signals to a corresponding processing unit. Each processing unit may be specifically configured to send received M×i×j fourth electrical signals to the processing module 230. i is a quantity of receive end heads corresponding to one receiving circuit, j is a quantity of receiving circuits corresponding to one processing unit, and i and j are natural numbers. In other words, each receiver front-end may receive the test signals transmitted by all the transmitter front-ends, and quantities of test signals received by all the receiver front-ends are the same.

In another possible design, each receiver front-end may be specifically configured to: receive k test signals from k transmitter front-ends, where k<M; and send k third electrical signals corresponding to the received k test signals to a corresponding receiving circuit. Each receiving circuit may be configured to: process received k×i third electrical signals to obtain k×i fourth electrical signals, and send the k×i fourth electrical signals to a corresponding processing unit. Each processing unit may be specifically configured to send received k×i×j fourth electrical signals to the processing module. In other words, each receiver front-end may receive test signals transmitted by some of the transmitter front-ends, and quantities of test signals received by all the receiver front-ends may be different.

It should be understood that, when the test signal transmitted by the transmitting module 210 is transmitted to the receiving module 220 through the medium, for example, through the housing of the box, the air inside the box, or the air outside the box, the test signal has changed. Therefore, the third electrical signal is different from the foregoing second electrical signal.

For ease of understanding, subsequent descriptions are provided by using an example in which each receiver front-end can receive the test signals transmitted by all the transmitter front-ends.

In an example, when Q=Z=1, N>1, and it is assumed that N=3, three receiver front-ends each receive the M test signals from the M transmitter front-ends, and each receiver front-end sends the M third electrical signals corresponding to the received M test signals to the receiving circuit. The receiving circuit processes received 3×M third electrical signals to obtain 3×M fourth electrical signals, and sends the 3×M fourth electrical signals to the processing unit. The processing unit then sends the 3×M fourth electrical signals to the processing module 230.

In another example, when Q=Z=N, and it is assumed that Q=Z=N=3, three receiver front-ends each receive the M test signals from the M transmitter front-ends, and each receiver front-end sends the M third electrical signals corresponding to the received M test signals to one corresponding receiving circuit. Each of the three receiving circuits processes the received M third electrical signals to obtain M fourth electrical signals, and sends the M fourth electrical signals to one corresponding processing unit. Each of the three processing units sends the received M fourth electrical signals to the processing module 230.

An operation of processing the third electrical signal by the receiving circuit may include at least one of the following: amplification, filtering, down-conversion, and attenuation.

In this application, the third electrical signal and the fourth electrical signal may be digital signals, or may be analog signals. This is not limited in this application.

For example, it is assumed that the third electrical signal is the analog signal, and the fourth electrical signal is the digital signal. Therefore, when receiving the M test signals from the M transmitter front-ends, each receiver front-end sends M analog signals corresponding to the M test signals to a corresponding receiving circuit. When receiving M×i analog signals, each receiving circuit separately performs amplification, filtering, down-conversion, attenuation, and digital-to-analog conversion on the analog signals to obtain M×i digital signals, and sends the M×i digital signals to a corresponding processing unit. Each processing unit sends received M×i×j digital signals to the processing module 230.

Optionally, when the test signal is the electrical signal, the N receiver front-ends are electrodes.

When the receiver front-end is the electrode, correspondingly, the transmitter front-end is also the electrode. Because the test signal transmitted by the transmitter front-end is still the electrical signal, when receiving the electrical signal, the receiver front-end directly sends the electrical signal to the receiving circuit without performing a processing operation.

Optionally, when the test signal is a mechanical wave signal obtained by converting the electrical signal, the M transmitter front-ends are transducers; or when the test signal is an electromagnetic wave signal obtained by converting the electrical signal, the M transmitter front-ends are antennas.

When the receiver front-end is the transducer, correspondingly, the transmitter front-end is also the transducer. Because the test signal transmitted by the transmitter front-end is the mechanical wave signal, when receiving the mechanical wave signal, the receiver front-end needs to convert the mechanical wave signal into the electrical signal (namely, the foregoing third electrical signal), and then send the electrical signal to the receiving circuit. When the receiver front-end is the antenna, correspondingly, the transmitter front-end is also the antenna. Because the test signal sent by the transmitter front-end is the electromagnetic wave signal, when receiving the electromagnetic wave signal, the receiver front-end also needs to convert the electromagnetic wave signal into the electrical signal (namely, the foregoing third electrical signal), and then sends the electrical signal to the receiving circuit.

When the receiver front-end is the antenna, the receiver front-end may be deployed on the air vent or the corner of the to-be-monitored box; or when the receiver front-end is the electrode or the transducer, the receiver front-end may be deployed on the outer wall, the door, or the edge of the to-be-monitored box.

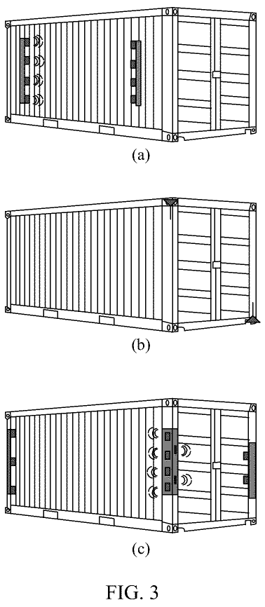

FIG. 3 is a diagram of deployment locations of a transmitting module and a receiving module according to an embodiment of this application.

Example 1: As shown in (a) in FIG. 3, the transmitting module and the receiving module may be deployed on an outer wall of a housing of a box.

Example 2: As shown in (b) in FIG. 3, the transmitting module and the receiving module may be deployed on an air vent of a box.

Example 3: As shown in (c) in FIG. 3, the transmitting module and the receiving module may be deployed on an edge of a housing of a box.

### Processing Module 230:

A deployment location of the processing module 230 is first described.

The processing module 230 may be deployed in the following several manners.

In a manner, the processing module 230 is deployed independently of the receiving module 220 and the transmitting module 210. In this case, the processing module 230 may be further deployed in the following two manners: a1 and a2.

a1. The processing module 230 may be transported with a to-be-monitored box. In this case, the processing module 230 may be located on the to-be-monitored box, or may be located on a transport device that transports the to-be-monitored box.

It should be understood that the processing module 230 may be located at any location on the to-be-monitored box, or may be located at any location of the transport device, for example, may be deployed in an operator cabin of the transport device.

Optionally, the processing module 230 may also be deployed in a magnetic absorbing manner or a clamping manner.

a2. The processing module 230 is not transported with a to-be-monitored box. In this case, the processing module 230 may be placed at a customhouse or a transportation node. In this case, the processing module 230 may be designed as an independent portable device.

For example, during customhouse transportation, one processing module 230 may be placed at each customhouse or each transportation node; or during cold chain transportation or dangerous goods transportation, one processing module 230 may be placed at each transportation node.

Optionally, the processing module 230 and the receiving module 220 may be connected in a wireless manner, or may be connected in a wired manner.

If a location of the processing module 230 is close to a location of a processing unit in the receiving module 220, the processing module 230 may be connected to the receiving module 220 in the wired manner; or if a location of the processing module 230 is far from a location of a processing unit in the receiving module 220, the processing module 230 may be connected to the receiving module 220 in the wireless manner.

In an example, when the processing module 230 and the processing unit in the receiving module 220 are both deployed on a side wall of a housing of a container, the processing module 230 and the receiving module 220 may be connected in the wired manner.

In another example, when the processing module 230 is deployed in the operator cabin of the transport device, and the processing unit in the receiving module 220 is deployed on the to-be-monitored box, the processing module 230 and the receiving module 220 may be connected in the wireless manner.

In still another example, when the processing module 230 is deployed at the customhouse or the transportation node, when a transport tool transports goods to the customhouse or the transportation node, the processing module 230 and the receiving module 220 may be connected in the wireless or wired manner.

In another manner, the processing module 230 and the receiving module 220 are integrated. In this case, the processing module 230 may be further deployed in the following three manners: b1 to b3.

b1. When a quantity of processing modules 230 is 1, the processing module 230 is integrated with any one of Q processing units of the receiving module 220.

When a function of the processing module 230 is integrated into a processing unit in the Q processing units of the receiving module 220, all processing units other than the processing unit integrated with the processing module 230 send the foregoing fourth electrical signal to the processing unit.

b2. When a quantity of processing modules 230 is greater than 1 and less than Q, the processing modules 230 are integrated with some of Q processing units of the receiving module 220.

When a function of the processing module 230 is integrated in some of the Q processing units of the receiving module 220, a processing unit other than the processing units integrated with the processing modules 230 may send a fourth electrical signal, and a person skilled in the art may design, based on an actual requirement, a specific processing unit that is integrated with the function of the processing module 230 and to which the fourth electrical signal of the other processing unit is specifically sent.

For example, it is assumed that there are two processing modules 230: A1 and A2, and there are five processing units of the receiving module 220: B1, B2, B3, B4, and B5. B1 and A1 may be integrated, B2 and A2 may be integrated, B3 may send the fourth electrical signal to B1 integrated with A1, and B4 and B5 may send the fourth electrical signal to B2 integrated with A2.

b3. When a quantity of receiving modules 220 is equal to Q, the processing module 230 is integrated with each of Q processing units of the receiving module 220.

For any processing unit and any processing module 230, if the processing unit and the processing module 230 are deployed together in an encapsulation form, the processing unit still needs to send a fourth electrical signal to the processing module 230; or if the processing unit integrates a function of the processing module 230, the processing unit does not need to send a fourth electrical signal.

It should be understood that a person skilled in the art may alternatively combine a manner of independently deploying the processing module 230 and a manner of integrating the processing module 230 with the receiving module 220. This is not limited in this application. For example, some processing units in the receiving module 220 may be integrated with the processing module 230, and the processing module 230 may be deployed at the customhouse or the transportation node to receive an electrical signal of a processing unit that is not integrated with the processing module 230.

Then, the function of the processing module 230 is described.

The processing module 230 is configured to: determine a channel characteristic based on an electrical signal corresponding to a test signal, and determine, based on the channel characteristic and an initial channel characteristic, whether a state of the box changes, where the initial channel characteristic represents a corresponding channel characteristic of the test signal transmitted by the transmitting module to the receiving module when the box is in an initial state.

The initial channel characteristic is the channel characteristic in the initial state, and the channel characteristic is determined based on the test signal transmitted by the transmitting module 210 to the receiving module 220.

In other words, the initial channel characteristic may be understood as a channel characteristic of a medium through which the test signal passes each time a transport device that transports goods arrives at a customhouse or a transportation node and when the test signal transmitted by the transmitting module 210 arrives at the receiving module 220 at the current customhouse or transportation node, and the channel characteristic may represent a current state of the box.

The current state of the box may also be referred to as the initial state of the box, and may be understood as a state of a housing of the box at the current customhouse or transportation node, and a state of the goods in the box, for example, a degree of damage to the housing of the box and a location of the goods in the box.

When receiving the fourth electrical signal from the processing unit in the receiving module 220, the processing module 230 may determine, based on the received fourth electrical signal, the channel characteristic of the medium through which the test signal passes, and compare the channel characteristic with a pre-stored initial channel characteristic, to determine whether the state of the box changes relative to the initial state of the box. When the state of the box changes greatly relative to the initial state of the box, it indicates that there is a security exception of the goods.

A process in which the processing module 230 compares the determined channel characteristic with the initial channel characteristic to determine whether the state of the box changes may be performed in a goods transportation process, or may be performed at the customhouse or the transportation node.

In an example, the processing module 230 is deployed independently of the receiving module 220 and the transmitting module 210. It should be understood that there is one processing module 230 in this case.

As described above, each processing unit in the receiving module 220 may send, to the processing module 230, M×i×j fourth electrical signals received from a corresponding receiving circuit. In this case, the processing module 230 may receive M×i×j×Q fourth electrical signals each time, and the processing module 230 may determine, based on these fourth electrical signals, the channel characteristic of the medium through which the test signal passes.

When the processing module 230 is transported together with the to-be-monitored box, in a transportation stage, the transmitting module 210 may send the test signal in real time. Each time the receiving module 220 receives the test signal, each processing unit in the receiving module 220 may send the determined M×i×j fourth electrical signals to the processing module 230 in real time. Once receiving the M×i×j×Q fourth electrical signals from all processing units, the processing module 230 may immediately determine the channel characteristic of the medium through which the test signal passes, and compare the determined channel characteristic with the pre-stored initial channel characteristic to determine whether the state of the box changes. It can be learned that, in this manner, real-time monitoring of the state of the to-be-monitored box can be implemented.

When the processing module 230 is not transported with the to-be-monitored box, for example, when the processing module 230 is placed at the customhouse or the transportation node, in a transportation stage, the transmitting module 210 may send the test signal at a preset time interval. Each time the receiving module 220 receives the test signal, each processing unit in the receiving module 220 determines the M×i×j fourth electrical signals, and then stores these fourth electrical signals locally. In other words, in the transportation process, each processing unit may locally store the M×i×j fourth electrical signals at a plurality of time points in the transportation process. When the transport device transports the goods to the customhouse or the transportation node, the processing module 230 is communicatively connected to the receiving module 220, and each processing unit may send the locally stored M×i×j fourth electrical signals to the processing module 230 at the plurality of time points in the transportation process. Therefore, the processing module 230 may receive the M×i×j×Q fourth electrical signals at the plurality of time points in the transportation process, determine a channel characteristic of a medium through which the test signal passes at each time point, and compare the channel characteristic determined at each time point with the pre-stored initial channel characteristic one by one, to determine whether the state of the box changes in the transportation process. For example, it is assumed that the processing module 230 determines that a difference between a channel characteristic determined at a time point and the pre-stored initial channel characteristic is large. In this case, it indicates that the state of the box changes in the transportation process. It can be learned that this manner can avoid that monitoring data is not transferred out of the customhouse or the transportation node. This ensures security of the monitoring data.

In another example, the processing module 230 and the receiving module 220 are integrated.

When a quantity of processing modules 230 is 1, and the processing module 230 is integrated with a processing unit in the Q processing units of the receiving module 220, another processing unit may send, to the processing unit, M×i×j fourth electrical signals received from a corresponding receiving circuit. Therefore, the processing unit may receive M×i×j×(Q−1) fourth electrical signals each time, and the processing module 230 may determine, based on the received fourth electrical signals and the locally determined M×i×j electrical signals, the channel characteristic of the medium through which the test signal passes.

Similarly, in a transportation stage, the transmitting module 210 may send the test signal in real time. Each time the receiving module 220 receives the test signal, all processing units other than the processing unit integrated with the processing module 230 may each send the determined M×i×j fourth electrical signals to the processing unit in real time. Once receiving the fourth electrical signals from other processing units, the processing unit may determine, in combination with the locally determined fourth electrical signals, the channel characteristic of the medium through the test signal passes, compare the determined channel characteristic with the pre-stored initial channel characteristic to determine whether the state of the box changes.

When a quantity of processing modules 230 is Q, and the processing module 230 is integrated with each of the Q processing units in the receiving module 220, when receiving M×i×j fourth electrical signals from a corresponding receiving circuit, each processing unit may locally determine the channel characteristic of the medium through which the test signal passes.

Similarly, in a transportation stage, the transmitting module 210 may send the test signal in real time, and the receiving module 220 also receives the test signal in real time. Once each processing unit in the receiving module 220 receives the M×i×j fourth electrical signals from the corresponding receiving circuit, each processing unit may determine, based on the received fourth electrical signals, the channel characteristic of the medium through which the test signal passes, compare the determined channel characteristic with the pre-stored initial channel characteristic to determine whether the state of the box changes. Once the processing unit determines that the state of the box changes, it indicates that there is a security exception of the goods.

It should be understood that, in a case in which the quantity of processing modules 230 is greater than 1 and less than Q, in other words, the processing module 230 is integrated with some of the Q processing units in the receiving module 220, real-time monitoring in the goods transportation stage may also be implemented. Details are not described herein again.

It can be learned that, when the quantity of processing modules 230 is 1, regardless of whether the processing module 230 is independently deployed or integrated with a processing unit in the receiving module 220, because the processing module 230 may receive electrical signals from a plurality of processing units, in other words, the processing module 230 compares a channel characteristic corresponding to a large quantity of electrical signals with the initial channel characteristic, precision of a comparison result is higher.

When the quantity of processing modules 230 is Q, each processing unit is integrated with one processing module 230, and each processing module 230 may determine, by comparing a channel characteristic corresponding to a small quantity of electrical signals with the initial channel characteristic, whether the state of the box changes. Therefore, the processing module 230 processes a small amount of data. This improves efficiency of determining the state of the box.

The following briefly describes a process of obtaining the initial channel characteristic.

The initial channel characteristic is obtained through training in the initial state.

Each time the to-be-monitored box is transported to a customhouse or a transportation node, an initial channel characteristic at the current customhouse or transportation node may be obtained by using the transmitting module 210, the receiving module 220, and the processing module 230 that are deployed on the to-be-monitored box and/or an area that is on the transport device and that is relatively static with the box. In other words, each time the box arrives at the customhouse or the transportation node, the transmitting module 210 may transmit a test signal. After receiving the test signal, the receiving module 220 sends an electrical signal corresponding to the test signal to the processing module 230. The processing module 230 determines a corresponding channel characteristic based on the received electrical signal, and stores the channel characteristic as an initial channel characteristic. The initial channel characteristic may represent a current state of the box.

In short, each time the to-be-monitored box arrives at the customhouse or the transport node, the monitoring device 200 may obtain and store the initial channel characteristic once. In the goods transportation process, the monitoring device 200 monitors the state of the box.

For example, before the goods are delivered from a customhouse A, after the monitoring device 200 obtains and stores an initial channel characteristic at the customhouse A, the goods are transported to a customhouse B by using the transport device. In a transportation process of transporting the goods from the customhouse A to the customhouse B, the monitoring device 200 may determine a channel characteristic of the box in the transportation process, and compare the channel characteristic with the initial channel characteristic stored at the customhouse A, to determine whether the goods in the box are safe. When the goods arrive at the customhouse B, the monitoring device 200 re-obtains and stores an initial channel characteristic, and then delivers the goods to the customhouse A. In a transportation process of transporting the goods from the customhouse A to the customhouse A, the monitoring device 200 may determine a channel characteristic of the box in the transportation process, and compare the channel characteristic with the initial channel characteristic stored at the customhouse B, to determine whether the goods in the box are safe.

It should be understood that, in this application, the initial channel characteristic is obtained at the customhouse or the transportation node because there is usually a process of changing a vehicle and reloading the to-be-monitored box at the customhouse or the transportation node, and different vehicle models and different vehicle structures affect the channel characteristic. In addition, there are a large quantity of workers at the customhouse or the transportation node, and there is usually no illegal activities (for example, damaging the box and stealing the goods) of lawbreakers. In this case, the goods in the box are safe. Therefore, the initial channel characteristic obtained at the customhouse or the transportation node can reflect the state of the box under the premise of security. A reason why the box is monitored in the transportation stage is that the illegal activities of the lawbreakers often occur in the transportation process, or the goods in the box are often shifted (for example, oil in an oil tank truck shakes violently) due to an excessively high vehicle speed in the transportation process, causing a security risk. Therefore, in the transportation process, the monitoring device 200 needs to be used to monitor the state of the box.

Optionally, to distinguish whether the monitoring device 200 is used to obtain the initial channel characteristic or monitor the box, the monitoring device 200 may further include a control module. The control module may send a control instruction to the processing module 230, where the control instruction may be a training instruction or a monitoring instruction.

When the processing module 230 receives the training instruction, the processing module 230 performs a process of obtaining the initial channel characteristic; or when the processing module 230 receives the monitoring instruction, the processing module 230 performs a process of determining whether the state of the box changes.

The control module may be a remote controller, and the remote controller may be controlled by a worker.

Optionally, the monitoring device 200 may further include an alarm module. The processing module 230 is further configured to send an alarm instruction to the alarm module when determining that the state of the box changes. The alarm module is configured to send an alarm signal based on the alarm instruction.

The alarm module may be a loudspeaker or a flashing light.

When the processing module 230 determines that the state of the box in the transportation process greatly changes relative to the state of the box at the customhouse or the transportation node, in other words, the determined channel characteristic is greatly different from the initial channel characteristic, the processing module 230 may send the alarm instruction to the alarm module. If the alarm module is the loudspeaker, the alarm module may send a voice alarm message based on the alarm instruction. If the alarm module is the flashing light, the alarm module may emit bright light based on the alarm instruction. After being reminded, a driver or the worker may check the box to identify a security risk in time.

Based on the foregoing designed monitoring device, the transmitting module that is relatively static with the box transmits the test signal, the receiving module that is relatively static with the box receives the test signal, and then the processing module determines the channel characteristic based on the electrical signal corresponding to the test signal, so that when the state of the box changes, for example, a location of the goods moves or the box is damaged, it can be monitored that the channel characteristic changes relative to the initial channel characteristic. In other words, regardless of whether the box is damaged or the state of the goods in the box changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

This application further provides a container. The container includes:
a box;
a transmitting module, located inside or outside the box and/or located in an area that is on a transport device of the box and that is relatively static with the box, and configured to transmit a test signal;
a receiving module, located inside or outside the box and/or located in the area that is on the transport device of the box and that is relatively static with the box, and configured to receive the test signal; and
a processing module, configured to: determine a channel characteristic based on an electrical signal corresponding to the test signal, and determine, based on the channel characteristic and an initial channel characteristic, whether a state of the box changes, where the initial channel characteristic represents a corresponding channel characteristic of the test signal transmitted by the transmitting module to the receiving module when the box is in an initial state.

When the transmitting module and the receiving module are located inside the box, the transmitting module and the receiving module may be located on an inner wall, a corner, an edge, a door, or an air vent inside the box; or when the transmitting module and the receiving module are located outside the box, the transmitting module and the receiving module may be located on an outer wall, a corner, an edge, a door, or an air vent of a housing of the box.

It should be understood that, in a case in which the transmitting module and the receiving module are deployed inside the box, the transmitting module and the receiving module may be deployed inside the box before the container is delivered from a factory, in other words, before goods are loaded inside the box, for example, deployed on the inner wall of the box, so that the transmitting module and the receiving module are delivered from the factory together with the box.

It should be further understood that the transmitting module, the receiving module, and the processing module that are included in the container jointly constitute the foregoing monitoring device shown in FIG. 2. A function of the monitoring device is the same as a function of the monitoring device shown in FIG. 2. For details, refer to the foregoing descriptions. Details are not described herein again.

Based on the container, the transmitting module that is relatively static with the box transmits the test signal, the receiving module that is relatively static with the box receives the test signal, and then the processing module determines the channel characteristic based on the electrical signal corresponding to the test signal, so that when the state of the box changes, for example, a location of the goods moves or the box is damaged, it can be monitored that the channel characteristic changes relative to the initial channel characteristic. In other words, regardless of whether the box of the container is damaged or a state of the goods in the box of the container changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

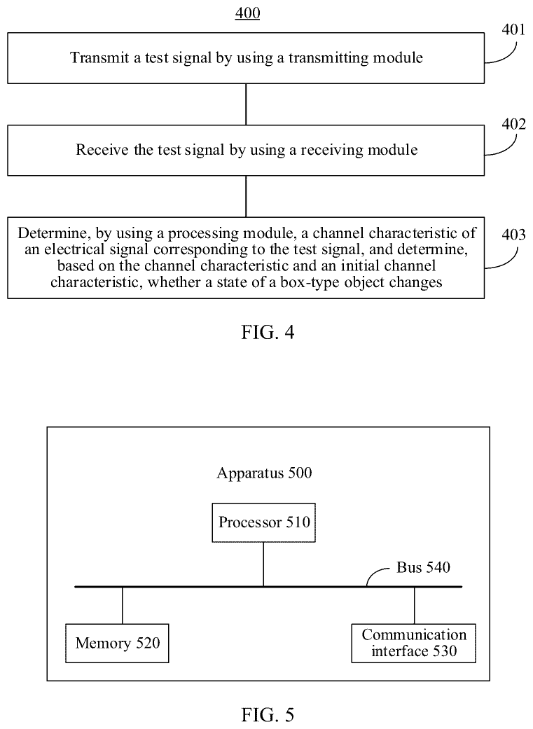

With reference to FIG. 4, the following describes an example of a process of a method for monitoring a box-type object provided in this application.

FIG. 4 is a schematic flowchart of a method for monitoring a box-type object according to an embodiment of this application. The method 400 is applied to the monitoring device 200 shown in FIG. 2, and the method 400 includes step 401 to step 403. The method 400 may be performed by a controller, may be performed by a component (for example, a chip or a chip system) configured in the controller, or may be implemented by a logical module or software that can implement all or some of controller functions. This is not limited in this application. The controller may be configured to control each module in the monitoring device to perform the foregoing functions. The controller may be a device that has a communication connection to the monitoring device, or may be a module integrated into the monitoring device. This is not limited in this application.

For ease of description, the following uses the controller as an example to describe the method 400 for monitoring a box-type object.

Step 401: Control a transmitting module to transmit a test signal.

Step 402: Control a receiving module to receive the test signal.

Step 403: Control a processing module to determine a channel characteristic of an electrical signal corresponding to the test signal, and determine, based on the channel characteristic and an initial channel characteristic, whether a state of the box-type object changes, where the initial channel characteristic represents a corresponding channel characteristic of the test signal transmitted by the transmitting module to the receiving module when the box-type object is in an initial state.

It should be understood that the box-type object in the method 400 may be referred to as a box for short, for example, may include the foregoing box.

The test signal includes a mechanical wave signal, a direct current signal, or an electromagnetic wave signal.

The channel characteristic is a channel characteristic of a medium through which the test signal passes when the test signal transmitted by the transmitting module arrives at the receiving module in a process of transporting goods by a transport device. The channel characteristic may represent a state of the box in the transportation process.

The initial channel characteristic is a channel characteristic of a medium through which the test signal passes each time the transport device that transports the goods arrives at a customhouse or a transportation node and when the test signal transmitted by the transmitting module arrives at the receiving module at the current customhouse or transportation node. The channel characteristic may represent a current state of the box, and the current state of the box is also the initial state of the box. For example, the state is a degree of damage to a housing of the box, and a state of the goods in the box, for example, a location of the goods in the box when the box is located at the current customhouse or transportation node.

In step 401 to step 403, when the box is in the transportation process, the controller may control the transmitting module to transmit the test signal, and control the receiving module to receive the test signal, and send the electrical signal corresponding to the test signal to the processing module. The controller may also control the processing module to receive the electrical signal, so that after determining the channel characteristic of the electrical signal, the processing module compares the channel characteristic with the initial channel characteristic, and when a difference between the channel characteristic and the initial channel characteristic is large, it indicates that the box has a security risk; or when a difference between the channel characteristic and the initial channel characteristic is small or there is almost no difference, it indicates that the box has no security risk.

Optionally, the method further includes: performing training based on the test signal transmitted by the transmitting module to the receiving module in the initial state, to obtain the channel characteristic in the initial state.

Each time the box arrives at a customhouse or a transportation node, the controller may also control the transmitting module to transmit the test signal, and control the receiving module to receive the test signal. After determining the channel characteristic of the electrical signal corresponding to the test signal, the processing module stores the channel characteristic as the initial channel characteristic.

It should be understood that for a method for using the monitoring device 200 and function implementation of each module of the monitoring device 200, refer to the foregoing related descriptions of FIG. 2. Details are not described herein again.

Based on the foregoing method, the transmitting module that is relatively static with the box is controlled to transmit the test signal, the receiving module that is relatively static with the box is controlled to receive the test signal, and then the processing module is controlled to determine the channel characteristic based on the electrical signal corresponding to the test signal, so that when the state of the box changes, for example, a location of the goods moves or the box is damaged, it can be monitored that the channel characteristic changes relative to the initial channel characteristic. In other words, regardless of whether the box is damaged or the state of the goods in the box changes, the channel characteristic can be used to reflect this phenomenon. In this way, a state change of the box can be monitored without damaging the box, so that a security risk can be identified in time. In addition, a location of the monitoring device may be flexibly deployed, power consumption is low, and costs are also low.

FIG. 5 is a block diagram of an apparatus for monitoring a box-type object according to an embodiment of this application. The apparatus 500 may be a chip system. In this embodiment of this application, the chip system may include a chip, or may include a chip and another discrete component.

As shown in FIG. 5, the apparatus 500 may include at least one processor 510, configured to implement a function of the controller in the foregoing method embodiment.

For example, when the apparatus 500 is configured to implement a function of the controller in the embodiment shown in FIG. 4, the processor 510 may be configured to: control a transmitting module to transmit a test signal; control a receiving module to receive the test signal; and control a processing module to determine a channel characteristic of an electrical signal corresponding to the test signal, and determine, based on the channel characteristic and an initial channel characteristic, whether a state of the box-type object changes, where the initial channel characteristic represents a corresponding channel characteristic of the test signal transmitted by the transmitting module to the receiving module when the box-type object is in an initial state. For details, refer to the description in the method example. Details are not described herein again.

Optionally, the apparatus 500 may further include at least one memory 520, configured to store program instructions and/or data. The memory 520 is coupled to the processor 510. The coupling in this embodiment of this application may be an indirect coupling or a communication connection between apparatuses, units, or modules in an electrical form, a mechanical form, or another form, and is used for information exchange between the apparatuses, the units, or the modules. The processor 510 may collaboratively operate with the memory 520. The processor 510 may execute program instructions stored in the memory 520. At least one of the at least one memory may be included in the processor.

Optionally, the apparatus 500 may further include a communication interface 530, configured to communicate with another device (for example, a monitoring device) by using a transmission medium, so that the apparatus 500 may communicate with the another device. The communication interface 530 may be, for example, a transceiver, an interface, a bus, a circuit, or an apparatus that can implement a receiving and sending function. The processor 510 may receive and send data and/or information by using the communication interface 530, and is configured to implement a function of the controller in the foregoing method embodiment.

A specific connection medium between the processor 510, the memory 520, and the communication interface 530 is not limited in this embodiment of this application. In this embodiment of this application, in FIG. 5, the processor 510, the memory 520, and the communication interface 530 are connected by using a bus 540. The bus 540 is represented by a thick line in FIG. 5. A connection manner between other components is merely an example for description, and is not limited thereto. The bus may be classified into an address bus, a data bus, a control bus, and the like. For ease of representation, only one bold line is used for representation in FIG. 5, but it does not indicate that there is only one bus or only one type of bus.

This application further provides a chip system. The chip system includes at least one processor, configured to implement a function of the controller in the embodiment shown in FIG. 4, for example, receive or process data and/or information in the foregoing method.

In a possible design, the chip system further includes a memory. The memory is configured to store program instructions and data. The memory is located inside the processor or outside the processor.

The chip system may include a chip, or may include the chip and another discrete component.

This application further provides a computer program product. The computer program product includes a computer program (which may also be referred to as code or instructions). When the computer program is run, a computer is enabled to perform the method performed by the controller in the embodiment shown in FIG. 4.

This application further provides a computer-readable storage medium. The computer-readable storage medium stores a computer program (which may also be referred to as code or instructions). When the computer program is run, the computer is enabled to perform the method performed by the controller in the embodiment shown in FIG. 4.

It should be noted that the processor in embodiments of this application may be an integrated circuit chip, and has a signal processing capability. In an implementation process, steps in the foregoing method embodiments can be implemented by using a hardware integrated logical circuit in the processor, or by using instructions in a form of software. The foregoing processor may be a general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, or a discrete hardware component. It may implement or perform the methods, the steps, and logical block diagrams that are disclosed in embodiments of this application. The general-purpose processor may be a microprocessor, or the processor may be any conventional processor or the like. Steps of the methods disclosed with reference to embodiments of this application may be directly executed and accomplished by a hardware decoding processor, or may be executed and accomplished by using a combination of hardware and software modules in the decoding processor. A software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

It may be understood that the memory in embodiments of this application may be a volatile memory or a nonvolatile memory, or may include a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM). It should be noted that the memory of the systems and methods described in this specification includes but is not limited to these and any memory of another proper type.

Terms such as “unit” and “module” used in this specification may indicate computer-related entities, hardware, firmware, combinations of hardware and software, software, or software being executed.

A person of ordinary skill in the art may be aware that, with reference to various illustrative logical blocks (illustrative logical blocks) described in embodiments disclosed in this specification and steps (steps) may be implemented by electronic hardware or a combination of computer software and electronic hardware. Whether the functions are performed by hardware or software depends on particular applications and design constraint states of the technical solutions. A person skilled in the art may use different methods to implement the described functions for each particular application, but it should not be considered that the implementation goes beyond the scope of this application. In several embodiments provided in this application, it should be understood that the disclosed apparatuses, devices, and methods may be implemented in other manners. For example, the described apparatus embodiment is merely an example, and there may be another division manner during actual implementation. For example, a plurality of units or components may be combined or integrated into another system, or some characteristic s may be ignored or not performed. In addition, displayed or discussed mutual couplings or direct couplings or communication connections may be implemented through some interfaces. Indirect couplings or communication connections between the apparatuses or the units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

In the foregoing embodiments, all or some of the functions of the functional units may be implemented by using software, hardware, firmware, or any combination thereof. When the software is used to implement embodiments, all or some of embodiments may be implemented in a form of a computer program product. The computer program product includes one or more computer instructions (programs). When the computer program instructions (programs) are loaded and executed on the computer, the procedure or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

When the functions are implemented in the form of a software functional unit and sold or used as an independent product, the functions may be stored in a computer-readable storage medium. Based on such an understanding, the technical solutions of this application essentially, or a part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A monitoring device, comprising:
a transmitting module, located on a to-be-monitored box and/or located in an area that is on a transport device of the box and that is relatively static with the box, and configured to transmit a test signal;
a receiving module, located on the box and/or located in the area that is on the transport device and that is relatively static with the box, and configured to receive the test signal; and
a processing module, configured to: determine a channel characteristic based on an electrical signal corresponding to the test signal, and determine, based on the channel characteristic and an initial channel characteristic, whether a state of the box changes, wherein the initial channel characteristic represents a corresponding channel characteristic of the test signal transmitted by the transmitting module to the receiving module when the box is in an initial state.

2. The device according to claim 1, wherein the test signal comprises a mechanical wave signal, a direct current signal, or an electromagnetic wave signal.

3. The device according to claim 1, wherein when the transmitting module and the receiving module are located on the box, the transmitting module and the receiving module are specifically located on at least one of an outer wall, a corner, an edge, a door, or an air vent of a housing of the box.

4. The device according to claim 1, wherein the relatively static area comprises at least one of a chassis, a frame, a rear suspension, a fuel tank, or a drive bridge of the transport device.

5. The device according to claim 1, wherein the transmitting module comprises M transmitter front-ends and P processing units, each of the P processing units corresponds to at least one of the M transmitter front-ends, and M and P are natural numbers;
each processing unit is configured to: generate one electrical signal, and send the electrical signal to at least one corresponding transmitter front-end; and
each transmitter front-end is configured to transmit a test signal, wherein the test signal corresponds to the received electrical signal.

6. The device according to claim 5, wherein M=P, the P processing units are in one-to-one correspondence with the M transmitter front-ends, and each processing unit is configured to: generate the electrical signal, and send the electrical signal to the corresponding transmitter front-end.

7. The device according to claim 5, wherein the receiving module comprises N receiver front-ends and Q processing units, each of the Q processing units corresponds to at least one of the N receiver front-ends, and N and Q are natural numbers;
each receiver front-end is configured to: receive M test signals from the M transmitter front-ends, and send the M test signals to a corresponding processing unit; and
each processing unit is configured to send electrical signals corresponding to the received M test signals to the processing module.

8. The device according to claim 7, wherein N=Q, the Q processing units are in one-to-one correspondence with the N receiver front-ends, and each receiver front-end is configured to send the received M test signals to the corresponding processing unit.

9. The device according to claim 7, wherein the test signal is the electrical signal, and the M transmitter front-ends and the N receiver front-ends are electrodes.

10. The device according to claim 7, wherein the test signal is a mechanical wave signal obtained by converting the electrical signal, and the M transmitter front-ends and the N receiver front-ends are transducers; or the test signal is an electromagnetic wave signal obtained by converting the electrical signal, and the M transmitter front-ends and the N receiver front-ends are antennas.

11. The device according to claim 7, wherein the M transmitter front-ends are centrally distributed or discretely distributed, and the N receiver front-ends are centrally distributed or discretely distributed.

12. The device according to claim 1, wherein the initial channel characteristic is obtained through training in the initial state.

13. The device according to claim 1, wherein the receiving module and the processing module are integrated.

14. The device according to claim 1, wherein the device further comprises an alarm module;
the processing module is further configured to send an alarm instruction to the alarm module when determining that the state of the box changes; and
the alarm module is configured to send an alarm signal based on the alarm instruction.

15. A method for monitoring a box-type object, wherein the method comprises:
controlling a transmitting module to transmit a test signal;
controlling a receiving module to receive the test signal; and
controlling a processing module to determine a channel characteristic of an electrical signal corresponding to the test signal, and determine, based on the channel characteristic and an initial channel characteristic, whether a state of the box-type object changes, wherein the initial channel characteristic represents a corresponding channel characteristic of the test signal transmitted by the transmitting module to the receiving module when the box-type object is in an initial state.

16. The method according to claim 15, wherein the method further comprises:
performing training based on the test signal transmitted by the transmitting module to the receiving module in the initial state, to obtain the channel characteristic in the initial state.
